(19) United States
(12) Patent Application Publication
(10) Pub. No.: US 2010/0105334 A1
(43) Pub. Date: Apr. 29, 2010

(54) RADIO LINK CONTROL STATUS REPORTING AND POLLING

(75) Inventors: Stephen E. Terry, Northport, NY (US); Mohammed Sammour, Alrbieh (JO)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/429,793

(22) Filed: Apr. 24, 2009

Related U.S. Application Data
(60) Provisional application No. 61/048,125, filed on Apr. 25, 2008.
(60) Provisional application No. 61/098,680, filed on Sep. 19, 2008.

(51) Int. Cl. H04B 17/00

(52) U.S. Cl. 455/67.11

(57) ABSTRACT

A method and apparatus for processing, receiving and transmitting partial status reports. The method and apparatus includes disregarding a status report prohibit timer when transmitting a partial status report, creating a continuation status report and disregarding a poll prohibit timer when receiving a partial status report.

### CROSS REFERENCE TO RELATED APPLICATION

This application claims the benefit of U.S. Provisional Application Nos. 61/048,125, filed Apr. 25, 2008 and 61/098,680, filed Sep. 19, 2008 which are incorporated by reference as if fully set forth.

### FIELD OF INVENTION

This application is related to wireless communications.

### BACKGROUND

The Third Generation Partnership Project (3GPP) has initiated the Long Term Evolution (LTE) program to bring new technology, new network architecture, new configurations and new applications and services to wireless networks in order to provide improved spectral efficiency and faster user experiences. FIG. 1 shows an overview of an Evolved Universal Mobile Telecommunications System (UMTS) Terrestrial Radio Access Network (E-UTRAN) 100 in accordance with the prior art. As shown in FIG. 1, E-UTRAN 100 includes three eNodeBs (eNBs) 102, however, any number of eNBs may be included in E-UTRAN 100. The eNBs 102 are interconnected by an X2 interface 108. The eNBs 102 are connected by an S1 interface 106 to the Evolved Packet Core (EPC) 104. The EPC 104 includes a Mobility Management Entity (MME) 112 and a Serving Gateway (S-GW) 110.

FIG. 2 shows an LTE user-plane protocol stack 200 in accordance with the prior art. The protocol stack 200 is located in a WTRU 210 and includes the packet data control protocol (PDCP) 202, the radio link control (RLC) 204, the medium access control (MAC) 206 and the physical layer (PHY) 208. The protocol stack 200 may also reside in an eNB (not shown).

FIG. 3 shows an LTE control plane protocol stack 300 of the WTRU 210 of FIG. 2. The control plane protocol stack 300 includes the non-access stratum (NAS) 302 and a radio resource control (RRC) 304. Also included are the PDCP 306, RLC 308 and MAC 310 which together form the layer 2 sublayer 312.

The RLC (204, 308) has many functions. For example, the RLC (204, 308) may transfer upper layer protocol data units (PDUs) to lower layers in an acknowledge mode (AM) an unacknowledged mode (UM) or a transparent mode (TM). In AM, the RLC (204, 308) may receive an indication that delivery of the PDU was successful. The PDU may be sized to comply with size requirements of the lower layer. One or more PDUs may be formed from a single system data unit (SDU), which may be of a size that complies with RLC (204, 308) requirements. In other words, the RLC (204, 308) may be able to process transport blocks (TBs) that are larger than the lower layers can process, yet smaller than the higher layers can process.

When operating in AM, a transmitting entity may receive an acknowledgment if a data packet, such as a PDU or an SDU, is successfully transmitted to a receiving entity. For example, an RLC may transmit a packet. The RLC of the receiver of the packet may generate an RLC status report that may be transmitted back to the transmitting entity. The RLC status report may include an indicator that represents if transmission of the packet was successful. For example, if a WTRU transmits a set of RLC PDUs, and all the transmitted RLC PDUs were acknowledged by the receiving entity in an RLC status report, then delivery may be deemed successful. An indication of a successful delivery may be included in the RLC status report. However, if one or more of the RLC PDUs or PDU segments was not successfully received then the transmitting entity may receive an RLC status report that includes an indication of unsuccessful delivery. It may be noted that, in general, the receiving RLC entity transmits the status report to the transmitting entity. The transmitting RLC entity may request the report to be transmitted by the receiving RLC entity.

The RLC transmitting entity may poll a peer RLC entity to trigger the peer RLC entity to create a status report. Triggers to initiate polling may include transmission of the last data in a buffer and the expiration of a poll retransmit timer, for example.

When an RLC entity receives a poll from a peer entity, it may initiate the creation of a status report. The status report creation may also be triggered when the receiving RLC entity detects a reception failure of an RLC PDU. When the status report is triggered, the WTRU may first determine if the status prohibit timer is running. The status prohibit function (T_status_prohibit) is a timer that, while running, is used by the receiving RLC entity in order to prohibit transmission of a status PDU. While the timer is running, a status PDU may not be transmitted. The WTRU may wait for the status report prohibit timer to expire before sending the status PDU.

A status PDU includes a PDU payload and an RLC control PDU header. The fields in a status PDU include ACK_SN, E1, E2, NACK_SN and possibly a set of SOstart and SOend for each NACK_SN. ACK_SN indicates the sequence number (SN) of the next not received RLC data PDU which is not reported as missing in the status PDU. NACK_SN indicates the SN of the acknowledge mode data (AMD) PDU that has been detected as lost at the receiving RLC entity. SOstart and SOend are used together. These fields indicate the portion of the AMD PDU with SN equal to NACK_SN that has been detected as lost at the receiving RLC entity. SOstart indicates the position of the first byte and SOend indicates the position of the last byte. A receiving RLC entity may use various state variables. For example, VR(R) is the receive state variable that holds the value of the system number (SN) following the last in-sequence completely received AMD PDU, and serves as the lower edge of the receiving window. It is initially set to zero (0) and is updated when the receiving RLC entity receives an acknowledge mode data (AMD) PDU with SN equal to VR(R).

Another state variable is VR(MR). This is the maximum acceptable receive state variable. This state variable equals VR(R) plus the acknowledge mode window size and holds the value of the SN of the first AMD PDU that is beyond the receiving window. It serves as the higher edge of the receiving window.

Another state variable is VR(X)-T_reordering. This state variable holds the value of the SN following the SN of the RLC data PDU which triggered T_reordering. It is initially set to NULL.

VR(MS) is the maximum status transmit state variable and holds the highest possible value of the SN which can be indicated by the ACK_SN field when a status PDU needs to be constructed. It is initially set to zero (0). VR(H) is the highest received state variable. VR(H) holds the value of the SN following the SN of the RLC PDU with the highest SN among all received RLC data PDUs. It is initially set to zero (0).

A problem that may occur with status reporting is, once the status report is constructed, it may actually be too large to fit in a given uplink grant. If that occurs, the RLC entity may send a partial, or incomplete status report. The partial status report may include as many negative acknowledgments (NACKs) as possible, with an acknowledgement (ACK) corresponding to the last NACK in the report.

### SUMMARY

A method and apparatus for processing, receiving and transmitting partial status reports are disclosed. The method and apparatus may include disregarding a status report prohibit timer when transmitting a partial status report, creating a continuation status report and disregarding a poll prohibit timer when receiving a partial status report.

### BRIEF DESCRIPTION OF THE DRAWINGS

A more detailed understanding may be had from the following description, given by way of example in conjunction with the accompanying drawings wherein:

FIG. 1 shows an overview of an E-UTRAN in accordance with the prior art;

FIG. 2 shows an LTE user-plane protocol stack in accordance with the prior art;

FIG. 3 shows an LTE control-plane protocol stack in accordance with the prior art;

FIG. 4 shows an example wireless communication system including a plurality of WTRUs and an eNB in accordance with one embodiment;

FIG. 5 is a block diagram of a WTRU and the eNB of FIG. 4;

FIG. 6 is a flow diagram of a method of operating a timer in accordance with one embodiment;

FIG. 7 is a flow diagram of a method of delivering a status report in accordance with one embodiment;

FIG. 8 is a flow diagram of a method of creating a partial status report and triggering a continuation status report in accordance with one embodiment;

FIG. 9A is a flow diagram of a method of creating a continuation status report in accordance with one embodiment;

FIG. 9B is a flow diagram of a method of creating a continuation status report in accordance with another embodiment;

FIG. 10 is a flow diagram of a method of poll triggering in accordance with one embodiment; and

FIG. 11 is a flow diagram of a method of poll triggering in accordance with another embodiment.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

Each layer in a protocol stack may be implemented in a transmitting entity or a receiving entity. The entities may be devices or nodes in a wireless communication system. The wireless communication system may be based on a standard such as the 3GPP LTE or wideband code division multiple access (WCDMA) with high speed packet access (HSPA), for example. One skilled in the art may recognize that the methods and apparatus disclosed herein are not limited to any one communication system, standard, technology or device.

As used herein, the terms “short”, “partial” and “incomplete”, as used in reference to a status report, are synonymous and interchangeable. Furthermore, as used herein, the terms “long” and “complete”, as used in reference to a status report, are synonymous and interchangeable.

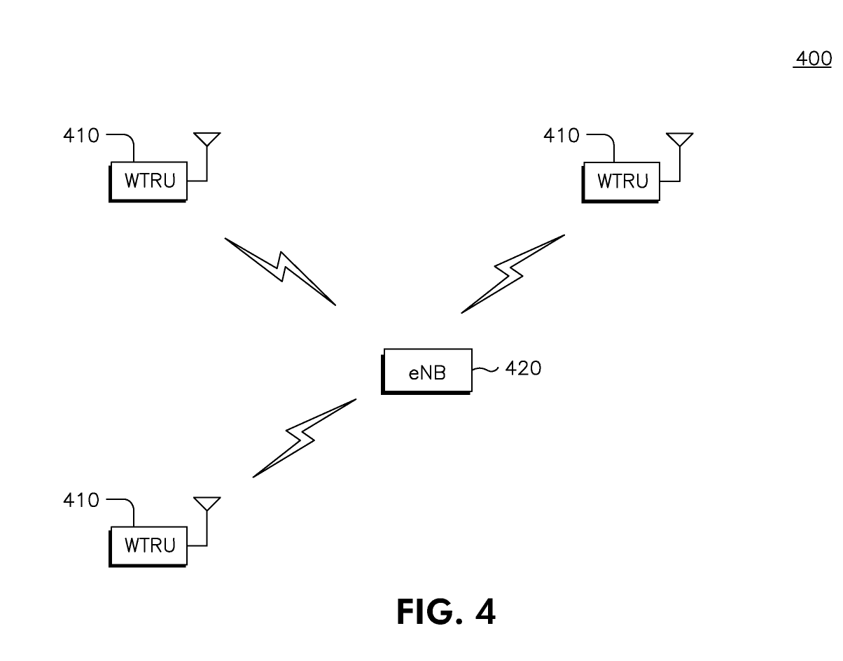

FIG. 4 shows a wireless communication system 400 including a plurality of WTRUs 410 and an e Node B (eNB) 420. As shown in FIG. 4, the WTRUs 410 are in communication with the eNB 420. Although three WTRUs 410 and one eNB 420 are shown in FIG. 4, it should be noted that any combination of wireless and wired devices may be included in the wireless communication system 400.

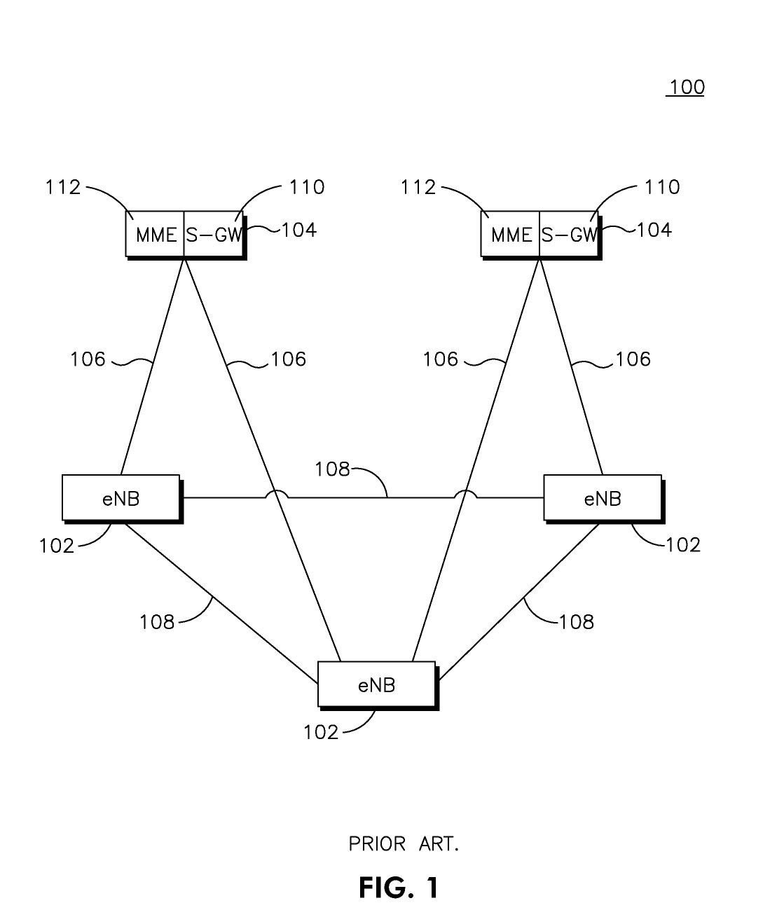

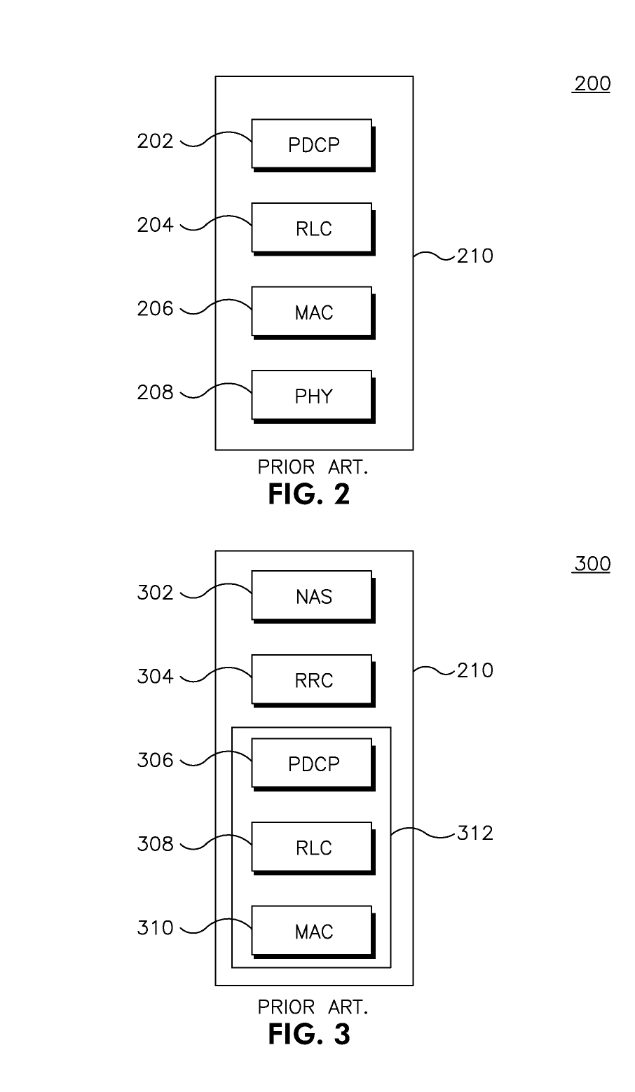

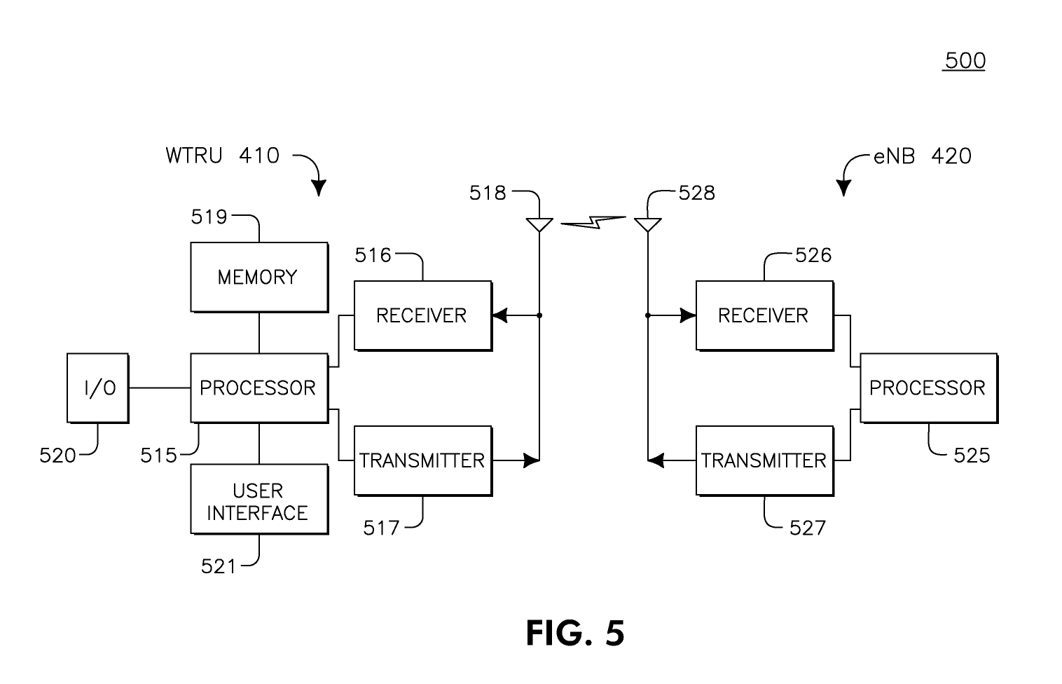

FIG. 5 is a functional block diagram 500 of a WTRU 410 and the eNB 420 of the wireless communication system 400 of FIG. 4. As shown in FIG. 4, the WTRU 410 is in communication with the eNB 420. The WTRU 410 is configured with both a user plane protocol stack (100 of FIG. 1) and control plane protocol stack (200 of FIG. 2). Each component in a stack is configured to communicate with components above and below it in the stack. Furthermore, each component in a stack is configured to communicate with its peer component in a peer protocol stack.

In addition to the components that may be found in a typical WTRU, the WTRU 410 includes a processor 515, a receiver 516, a transmitter 517, and an antenna 518. The WTRU 410 may also include a user interface 518, which may include, but is not limited to, an LCD or LED screen, a touch screen, a keyboard, a stylus, or any other typical input/output device. The WTRU 410 may also include memory 519, both volatile and non-volatile as well as interfaces 520 to other WTRU's, such as USB ports, serial ports and the like. The receiver 516 and the transmitter 517 are in communication with the processor 515. The antenna 518 is in communication with both the receiver 516 and the transmitter 517 to facilitate the transmission and reception of wireless data.

In addition to the components that may be found in a typical eNB, the eNB 420 includes a processor 525, a receiver 526, a transmitter 527, and an antenna 528. The receiver 526 and the transmitter 527 are in communication with the processor 525. The antenna 528 is in communication with both the receiver 526 and the transmitter 527 to facilitate the transmission and reception of wireless data.

A receiving RLC entity generates and transmits a status report to a transmitting RLC entity so that the transmitting RLC entity will know if the transmitted messages were received properly. The receiving RLC entity includes a status prohibit timer that controls a time at which the RLC entity may transmit a status report. While the timer is running, the RLC entity may not transmit a status report. When the timer expires, the RLC may transmit a status report if a new triggering condition occurs. The transmission of the status report starts the prohibit timer. This is used so that the RLC entity does not too frequently transmit status reports, resulting in unnecessary retransmissions.

Furthermore, the receiving RLC entity may only transmit messages in a time and frequency allocation that the RLC entity is given permission to use, that is, in the uplink (UL) grant. Once the RLC entity determines a status report triggering condition, it may discover that the complete status report does not fit into the UL grant. If that is the case, a partial status report may be transmitted. The partial status report is a subset of the complete status report that fits into the UL grant.

The transmission of a partial status report provides incomplete information to the transmitting RLC entity. Partial status report information may result in delayed RLC PDU and PDU segment transmission, that is, window stalling. It may also result in delayed retransmissions due to, for example, missing a negative acknowledgement. To reduce the probability of this occurring, the receiving RLC entity may keep track of the type of status report being transmitted in order to determine when to start the status prohibit timer. The status prohibit timer should only be started when complete status report information is transmitted by an RLC entity. The status prohibit timer should not be started when a partial status report is transmitted so that complete status information is not unnecessarily delayed. In this manner, further status reports that may have more complete information may be transmitted without waiting for the status report prohibit timer to expire.

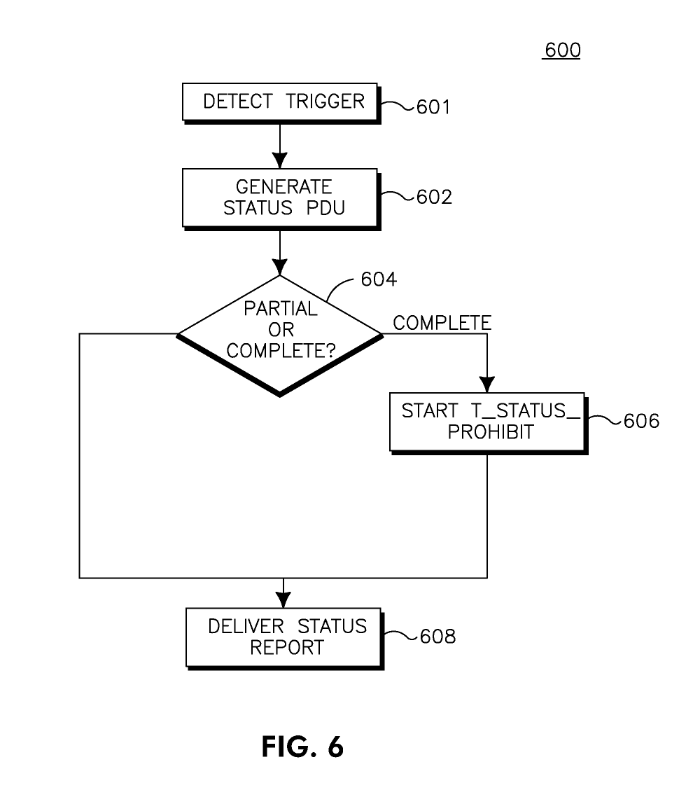

FIG. 6 is a flow diagram of a method of operating a timer 600 in accordance with one embodiment. At step 601a status report trigger condition is detected. The trigger may be poll based, timer based or based on missing data. At step 602, the RLC entity generates a status PDU. At step 604, the RLC entity determines if the status PDU includes a partial status report or a complete status report. The RLC entity may compare the ACK_SN of the status PDU to a state variable to determine if the status report is complete or partial. If, at step 604, the RLC entity determines that the status report is complete, at step 606, the RLC entity starts the status prohibition time. If, at step 604, the RLC entity determines that the status report is a partial status report, the status prohibit timer is not started so that subsequent status reports that are more complete are not delayed. At step 608 the status report is delivered to lower layers for transmission.

In an alternative embodiment, the receiving RLC entity may keep track of the type of status report being created in order to determine whether the status report should be transmitted no matter the state of the status report prohibit timer. Transmission of a partial status report should not be delayed by the status report prohibit timer.

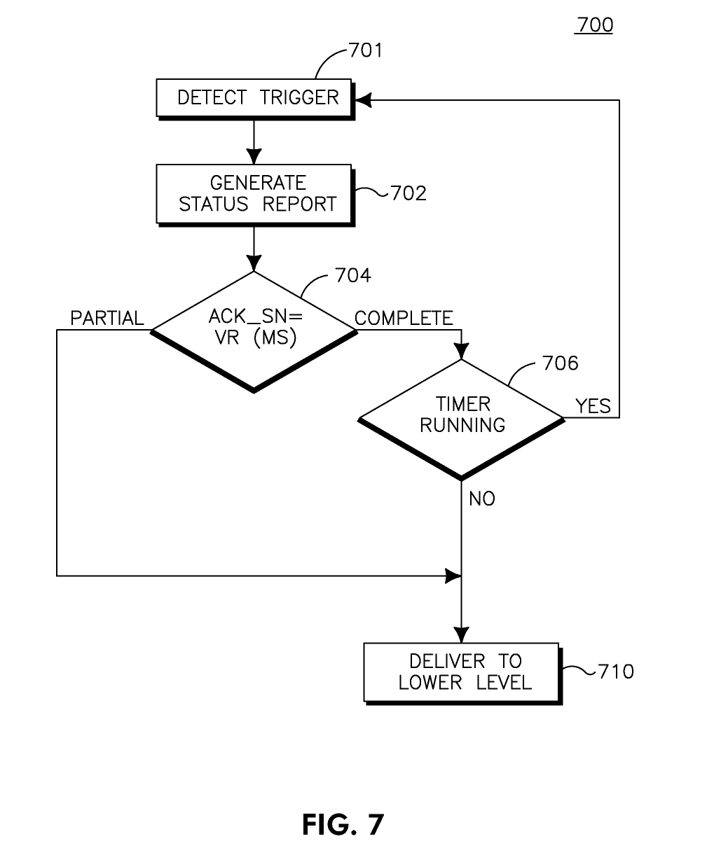

FIG. 7 is a flow diagram of a method of transmitting a status report 700 in accordance with the alternative embodiment. At step 701a status report triggering condition is detected. The triggering condition may be poll based, timer based or based on missing data. At step 702 the receiving RLC entity constructs the status report. At step 704, the RLC entity determines if the status report is partial or complete by comparing the ACK_SN to the state variable VR(MS). Other state variables may be used. If the status report is complete, at step 706 the RLC entity checks the status prohibit timer. If the timer is running, at step 708, the RLC entity will not deliver the status report to the lower layers and will return to step 701 to detect another trigger. The RLC entity will not deliver a complete status report until a trigger is received and the status report prohibit timer is not active. Both conditions must be met. However, if the timer is not running, as determined at step 706, or the status report is a partial status report, as determined at step 704, the status report is delivered to the lower layers at step 710.

In another alternative embodiment, separate status prohibit timers may be used. A first timer may be used in association with complete status reports. A second timer may be used in association with partial status reports. These prohibit timers may be set to different time periods. For example, the prohibit timer set for a partial status report may be shorter than the timer set for a complete status report

A third type of status report that may be transmitted by the receiving RLC entity and received by the transmitting RLC entity is a continuation status report. The RLC transmitting entity may trigger generation and transmission of a continuation status report that may be transmitted in a time transmission interval following a transmission of a partial status report. The continuation status report is intended to provide information for the transmitting RLC entity that is not included in the partial status report.

If the receiving RLC entity has not transmitted all the requested or required status reports relative to the time of the status report triggering event, it may generate and transmit a continuation status report at a permissible time in the future. The continuation status report may provide status information starting from the last acknowledged or not acknowledged SN in the previous partial status report or may include acknowledgements from the previous partial status report. The continuation status report may be another partial status report or a complete status report.

Generation of a partial status report may be considered a triggering criterion for a continuation status report. By way of example, a receiving RLC entity may receive a poll and a status report function may be triggered. The receiving RLC entity may be required to provide the status of PDUs received up to the received SN of the poll request. When only a partial status report can be transmitted, the receiving RLC entity may use a continuation status report to complete the required status report up to the polled SN or the latest received SN at the next transmission opportunity.

If the partial status report starts the status prohibit timer, the continuation status report may be transmitted if the status prohibit timer is running. Alternatively, the continuation status report may be delayed until the status prohibition timer has expired.

Prior to the status report being constructed, the receiving RLC entity may receive a poll from the transmitting RLC entity that triggers the creation of the report. The status report may be constructed based on the SN associated with the poll received from the transmitting RLC entity. The poll may require the status of PDUs up to the SN associated with the poll. However, the receiving RLC entity may not have sufficient time in the UL grant to transmit a status report that includes all PDUs up to the SN associated with the poll. If only a partial status report can be generated due to the UL grant, the receiving entity will maintain the triggering condition until a subsequent “continuation” status report can be generated acknowledging up to the SN associated with the original poll

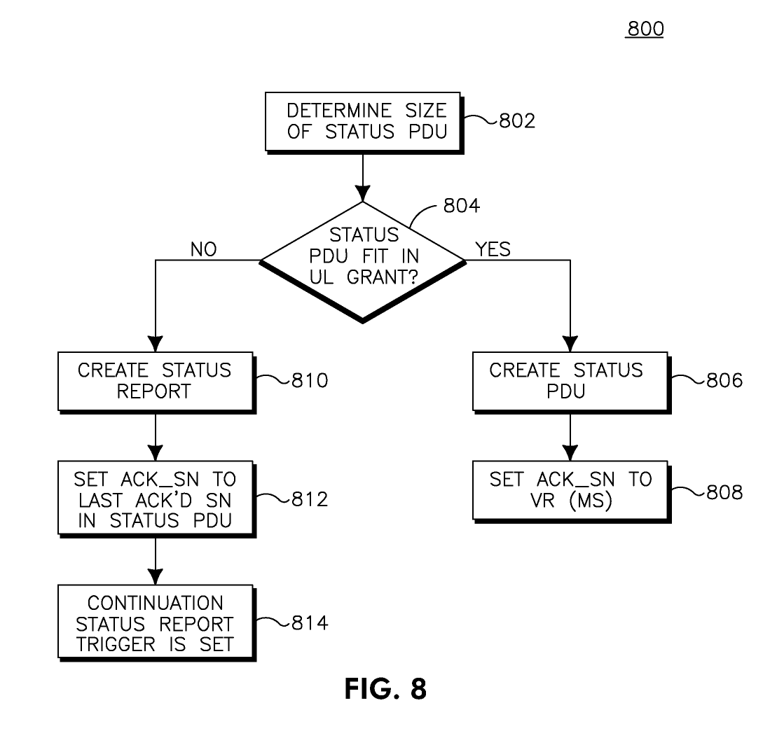

FIG. 8 is a flow diagram of a method of creating a partial status report 800 in accordance with one embodiment. At step 802, an RLC entity determines the required size of the status report. At step 804, the RLC entity determines if the status PDU fits into the UL grant. If so, at step 806, the RLC entity creates the complete report and, at step 808, sets ACK_SN to VR(MS). However, if the status report does not fit into the UL grant, the partial status report is created at step 810 and, at step 812, the ACK_SN is set to the last acknowledged PDU SN that could fit in the partial status report. The ACK_SN set as shown in step 812 may be used in a continuation report in a future reporting instance. The value of ACK_SN may be saved and used as the starting point for the next continuation report. Otherwise, the next continuation report may start from the first acknowledged SN in the partial status report. At step 814, a continuation status report trigger is set.

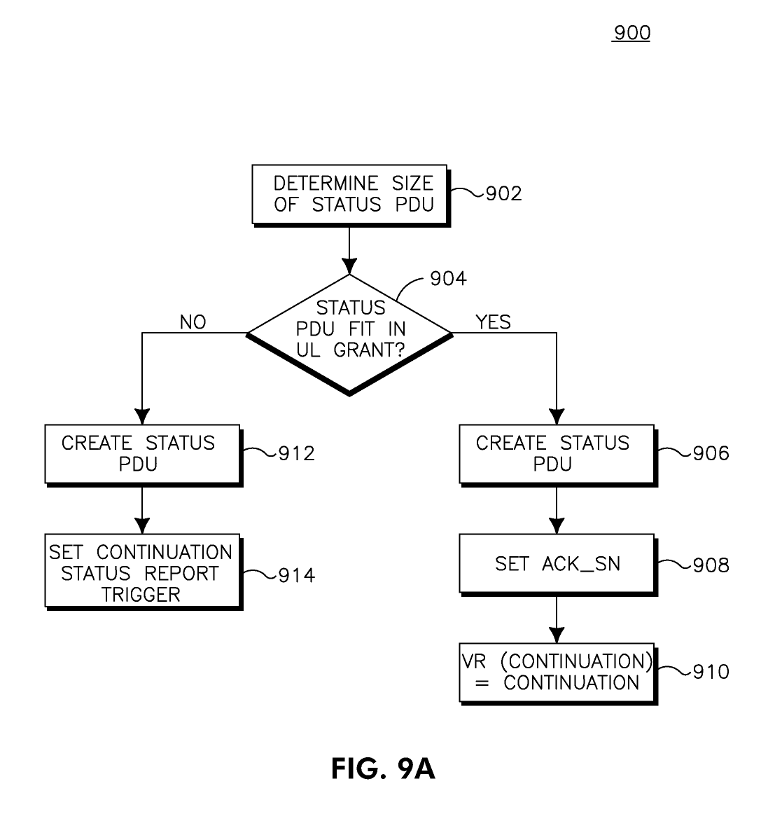

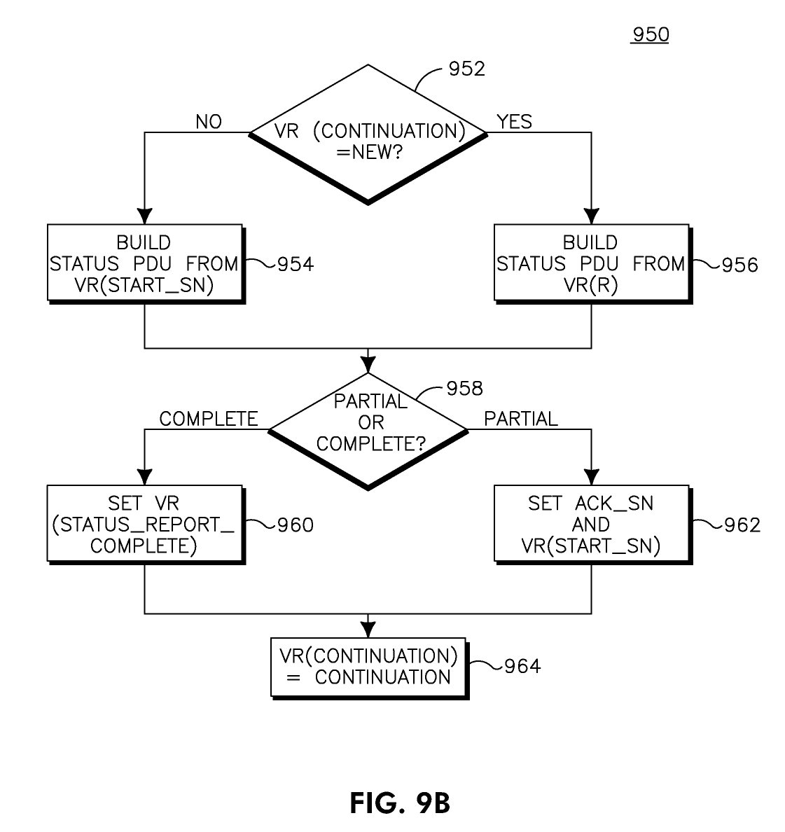

FIG. 9A is a flow diagram of a method of creating a continuation status report 900 in accordance with one embodiment. At step 902, the RLC entity determines the size of the status PDU. At step 904, the RLC entity determines if the complete continuation status PDU will fit into the uplink grant. If it is determined that the status PDU will fit into the UL grant, a complete continuation status report is generated. Similar to the method 800 shown in FIG. 8, the RLC entity creates the report at step 906 and, at step 908, sets ACK_SN accordingly. At step 910, the RLC entity sets the new state variable VR(continuation) to “continuation”. If, at step 904, it is determined that the status PDU does not fit into the UL grant, a partial continuation status report is generated at step 912 and a continuation status report trigger is set at step 914. The “continuation” indication identifies when a partial status report was previously created.

FIG. 9B is a flow diagram of a method of creating a continuation status report 950 in accordance with another embodiment. The RLC entity determines if the last status report was a partial report by checking the VR(continuation) state variable at step 952. The RLC entity may use other methods to determine if previous status reports were partial or complete. If the last status report was partial, at step 954, the RLC entity checks the VR(Start_SN) variable to determine the starting point for building the continuation status report. In another embodiment (not shown), the continuation report may be a superset that includes all acknowledgements from the previous partial status report. If the last report was complete, that is, VR(continuation) equals new, then the RLC entity may start building the status PDU from it normal point, such as VR(R), at step 956.

At step 958, the RLC entity determines if the continuation status report is partial or complete. If the status report is complete, at step 960, the state variable VR(status-report complete) is set. If the status report is partial, ACK_SN is set to the first SN not included in the status report, and VR(start) is set to ACK_SN, at step 962. At step 964, VR(continuation) is set to “continuation”, as the report created by method 950 is a continuation report.

The transmitting RLC entity may examine a received status report and detect whether the status report is partial or complete. The transmitting RLC entity may use the results of the detection to minimize transmission of duplicate data, which may occur due to the disabling or not starting of the status prohibit timer in the receiver, for example. The transmitting RLC entity may also use the results of the detection to reduce unnecessary polling that may occur, for example, when a continuation status report is expected.

The transmitting RLC entity may determine the status report type by determining if the received report contains an ACK or a NACK for a corresponding RLC data PDU stored in memory. If there is no ACK or NACK that corresponds to the RLC data PDU, then the status report may be determined to be partial. The transmitting RLC entity may also determine if the status report is partial or complete by checking the last, or highest acknowledged or not acknowledged sequence number (SN) within the received status report. If the SN is not the most recently transmitted SN or the SN associated with the most recent poll request, for example, an SN that is lower than an SN that corresponds to the transmitting entity's poll request, the received status report is determined to be a partial status report.

Similarly, an explicit indication may be transmitted with the status report to indicate if it is a complete or partial status report. A status PDU may include an explicit identifier, such as a field or a bit, for example, that is used by the RLC entity to differentiate between a partial status report and a complete status report. The transmitting RLC entity may use the identifier to easily identify the type of report, and may allow the transmitting entity to prepare for a continuation type report.

If the received status report is determined to be a partial report, the transmitting RLC entity may trigger an additional poll. The poll triggers the receiving RLC entity to send more complete status report information. The transmitting RLC entity may include a poll prohibit timer that may limit a number of polls that the transmitting RLC entity may send to the receiving RLC entity. For normal poll triggering events a poll may not be transmitted until the timer expires. However, a poll triggered by the reception of a partial status report may not be affected by the poll prohibit timer.

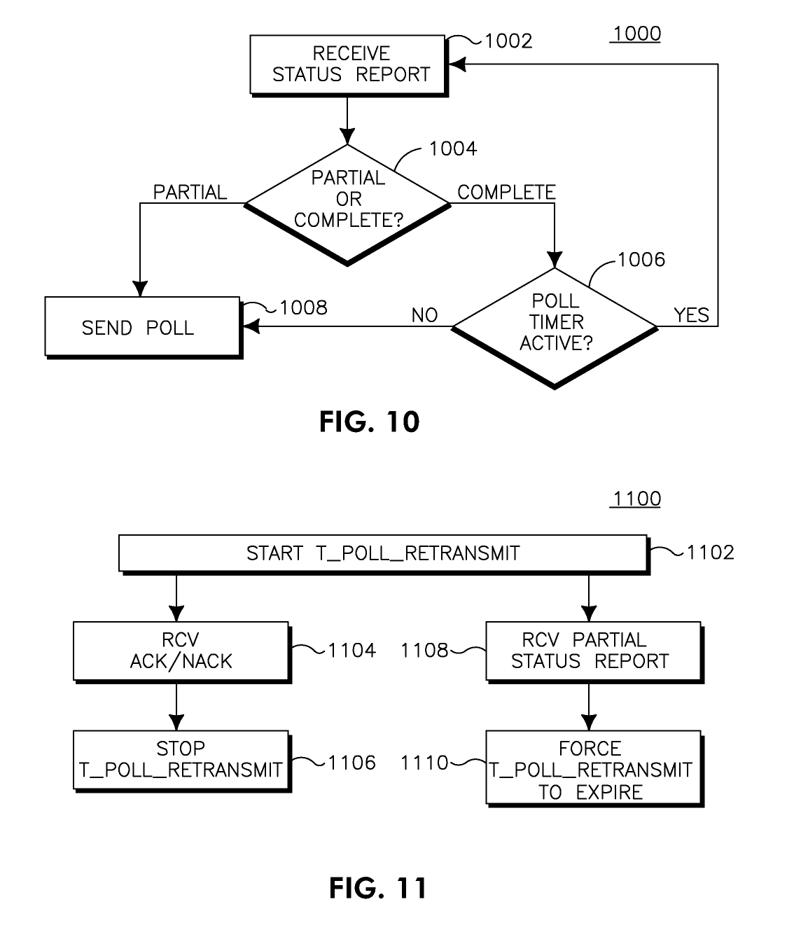

FIG. 10 is a flow diagram of a method of poll triggering in accordance with one embodiment. At step 1002 an RLC entity receives a status report. The reception of a status report may be a triggering event for transmitting a poll. Therefore, at step 1004, the RLC entity determines if the report is partial or complete. If the status report is partial, at step 1008, a poll is transmitted. If the status report is complete, at step 1006, the RLC checks the poll prohibit timer. If the timer is active the RLC entity returns to step 1002 to wait for the next triggering event, which may be a reception of another status report. Other triggers may be used. If the timer is inactive, the poll is transmitted at step 1008.

FIG. 11 is a flow diagram of a poll triggering method in accordance with another embodiment. At step 1102, a poll retransmit timer is started. At step 1104, the RLC entity receives an ACK or a NACK for an RLC data PDU with an associated SN stored in memory. At step 1106, the RLC entity stops the poll timer. If, however, at step 1108 the RLC receive a partial status report, at step 1110, the RLC entity forces the poll timer to expire. The RLC may proceed with the method as shown in FIG. 10.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of operating status report prohibit mechanism in a wireless transmit receive unit (WTRU), the method comprising:
generating a status report;
determining a completeness level of the status report;
starting the status report prohibit mechanism based on the completeness of the status report; and
transmitting the status report.

2. The method as in claim 1 further comprising:
generating a complete status report; and
starting the status prohibit mechanism.

3. The method as in claim 1 further comprising:
generating a partial status report; and
not starting the status prohibit mechanism.

4. A method of operating a status report prohibit mechanism in a wireless transmit receive unit (WTRU), the method comprising:
generating a status report;
determining a completeness level of the status report;
determining a state of the status report prohibit mechanism; and
transmitting the status report based on the state of the status report prohibit mechanism and the completeness level of the status report.

5. The method as in claim 4 further comprising:
determining the state of the status report prohibit mechanism is active;
determining the status report is a partial status report; and
transmitting the partial status report.

6. A method of transmitting a status report in a wireless transmit receive unit (WTRU), the method comprising:
generating a first status report;
determining a completeness level of the first status report;
triggering a creation of a second status report based on the completeness level of the first status report.

7. A method of status reporting in a wireless transmit receive unit (WTRU), the method comprising:
transmitting a partial status report with an end point;
creating a continuation status report starting from the end point; and
transmitting the continuation status report.

8. The method as in claim 7 wherein the end point comprises a sequence number of a last acknowledged data unit contained in the partial status report.

9. The method as in claim 7 further comprising:
generating the partial status report; and
setting a continuation status report trigger.

10. A method of polling in a wireless transmit receive unit (WTRU), the method comprising:
starting a poll prohibit mechanism;
receiving a status report;
determining whether the status report is partial; and
transmitting a status report poll.

11. The method as in claim 10 further comprising:
determining that the poll prohibit mechanism is activated; and
transmitting the status report poll.

12. The method as in claim 10 further comprising causing the poll prohibit mechanism to expire.

13. A method of determining a completeness level of a status report, the method comprising:
receiving a status report;
determining a first sequence number from the status report;
determining a second sequence number from a status report poll;
comparing the first sequence to a second sequence number; and
determining the completeness level based on the comparison.

14. The method as in claim 13 further comprising:
determining that the first sequence number is earlier than the second sequence number; and
determining that the status report is a partial status report.

15. A method of determining a type of status report, the method comprising:
receiving a status report;
determining an identifier from the status report; and
determining the type of status report based on the identifier from the status report.

16. The method as in claim 15, wherein the type of status report comprises continuation, partial or complete.

17. A wireless transmit receive unit (WTRU) comprising:
a status report prohibit mechanism;
a processor configured to:
generate a status report;
determine a completeness level of the status report; and
start the status report prohibit mechanism based on the completeness of the status report; and
a transmitter configured to transmit the status report.

18. The WTRU as in claim 17 wherein the processor is further configured to:
generate a complete status report; and
start the status prohibit mechanism.

19. The WTRU as in claim 17 wherein the processor is further configured to:
generate a partial status report; and
not start the status prohibit mechanism.

20. A wireless transmit receive unit (WTRU) comprising:
a status report prohibit mechanism;
a processor configured to:
generate a status report;
determine a completeness level of the status report;
determine a state of the status report prohibit mechanism; and
a transmitter configured to transmit the status report based on the state of the status report prohibit mechanism and the completeness level of the status report.

21. The WTRU as in claim 20 wherein the processor is further configured to:
determine whether the state of the status report prohibit mechanism is active; and
determine whether the status report is a partial status report; and
the transmitter is further configured to transmit the partial status report.

22. A wireless transmit receive unit (WTRU) configured to transmit a status report, the WTRU comprising:
a processor configured to:
generate a first status report;
determine a completeness level of the first status report; and
trigger a creation of a second status report based on the completeness level of the first status report.

23. A wireless transmit receive unit (WTRU) configured to transmit a status report, the WTRU comprising:
a transmitter configured to transmit a partial status report with an end point and a continuation status report; and
a processor configured to create the continuation status report starting from the end point.

24. The WTRU as in claim 23 wherein the end point comprises a sequence number of a last acknowledged data unit contained in the partial status report.

25. The WTRU as in claim 23 further comprising a processor configured to:
generate the partial status report; and
set a continuation status report trigger.

26. A wireless transmit receive unit (WTRU) configured to transmit a poll, the WTRU comprising:
a poll prohibit mechanism;
a receiver configured to receive a status report;
a processor configured to determine whether the status report is partial; and
a transmitter configured to transmit a status report poll.

27. The WTRU as in claim 26 wherein:
the processor is further configured to determine that the poll prohibit mechanism is activated; and
the transmitter is further configured to transmit the status report poll.

28. The WTRU as in claim 26 wherein the processor is further configured to cause the poll prohibit mechanism to expire.

29. A wireless transmit receive unit (WTRU) configured to determine a completeness level of a status report, the WTRU comprising:
a receiver configured to receiving a status report; and
a processor configured to:
determine a status report sequence number from the status report;
determine a status report poll sequence number from a status report poll;
compare the status report sequence number to the status report poll second sequence number; and
determine the completeness level based on the comparison.

30. The WTRU as in claim 29 wherein the processor is further configured to:
determine that the status report sequence number is earlier than the status report poll sequence number; and
determine that the status report is a partial status report.

31. A wireless transmit receive unit (WTRU) configured to determine a type of status report, the WTRU comprising:
a receiver configured to receive a status report; and
a processor configured to determine an identifier from the status report and determine the type of status report based on the identifier from the status report.

32. The WTRU as in claim 31, wherein the type of status report comprises continuation, partial or complete.
